(19) United States
(12) Patent Application Publication
(10) Pub. No.: US 2011/0235046 A1
(43) Pub. Date: Sep. 29, 2011

(54) IMAGING APPARATUS

(75) Inventors: Kazunori MARUYAMA, Kawasaki (JP); Shinya HASEGAWA, Kawasaki (JP); Akinori MIYAMOTO, Kawasaki (JP); Norihiko ITANI, Kawasaki (JP)

(73) Assignee: FUJITSU LIMITED, Kawasaki-shi (JP)

(21) Appl. No.: 13/070,024

(22) Filed: Mar. 23, 2011

(30) Foreign Application Priority Data
Mar. 24, 2010 (JP) 2010-67835

(51) Int. Cl. G01J 3/45

(52) U.S. Cl. 356/456

(57) ABSTRACT

An imaging apparatus includes an optical source configured to emit an electromagnetic wave, a wave dividing unit configured to divide the wave from the optical source into a first and a second wave beam, a probe optical source configured to emit a probe beam, a probe-beam dividing unit configured to divide the probe beam into a first and a second probe beam, a first crystal on which the first crystal is irradiated through an object and the first probe beam is incident, a second crystal on which the second crystal is irradiated through an object and the second probe beam is incident, an interference unit configured to allow the first probe beam from the first crystal to interfere with the second probe beam from the second crystal, and an image pickup device configured to capture an interference figure between the first and the second probe beam.

### CROSS-REFERENCE TO RELATED APPLICATION

This application is based upon and claims the benefit of priority of the prior Japanese Patent Application No. 2010-67835, filed on Mar. 24, 2010, the entire contents of which are incorporated herein by reference.

### FIELD

The present invention relates to an imaging apparatus.

### BACKGROUND

Terahertz waves are electromagnetic waves with frequencies of approximately 0.1 THz to 10 THz and cannot be imaged directly. A terahertz waves are able to pass through plastic, paper, cloth, and the like and have so-called fingerprint spectra inherent in individual substances.

For this reason, the measurement using a terahertz wave enables a substance analysis with spectral spectrum, visualization of the inside of a substance by terahertz-wave imaging, and the like without destruction or erosion.

Such terahertz waves can be generated by irradiating femtosecond laser beams with pulse widths of approximately 10 fsec to 100 fsec on, for example, a photoconduction antenna with a GaAs substrate; a semiconductor substrate, such as a GaP substrate; or a nonlinear optical crystal. The terahertz waves generated by these methods are pulse terahertz waves, such as those with pulse widths of approximately 1 psec, having a broadband frequency range in terahertz region.

In recent years, for example, the generation of electromagnetic waves in a terahertz region, i.e., terahertz waves, has become possible using a solid oscillator, such as a Gunn diode. The solid oscillator is a monochromatic light source because an oscillating frequency can be determined by the dimensions of a resonator or the like. In addition, a terahertz wave to be generated from the solid oscillator is one in continuous wave form.

Related art references include the following documents:
Japanese Patent No. 3388319;
Japanese Laid-open Patent Publication (Translation of PCT Application) No. 2003-525446;
Japanese Laid-open Patent Publication No. 2004-20504;
Japanese Laid-open Patent Publication No. 2004-354246;
Japanese Laid-open Patent Publication No. 2006-317407;
Japanese Laid-open Patent Publication (Translation of PCT Application) No. 2002-538423;
Japanese Laid-open Patent Publication No. 2005-315708; and
T. Loffler et al., “Continuous-wave terahertz imaging with a hybrid system”, Applied Physics Letters, Vol. 90, No. 9, pp. 091111-1-3, Mar. 1, 2007.

By the way, in the case of constructing an imaging apparatus where the above method for generating a terahertz wave using the femtosecond laser to visualize the inside of a substance is applied (see, for example FIG. 1), the amplitude information and the phase information of an object can be obtained because the terahertz wave is a pulse terahertz wave.

In other words, the femtosecond layer can be also used for the detection of a terahertz wave to synchronize the generation of the terahertz wave and the detection thereof, thereby not only acquiring the amplitude information of the terahertz wave passing through (or reflecting from) an object but also acquiring the phase information thereof.

However, in the case of constructing the image apparatus where the above method for generating a terahertz wave using the femtosecond laser as illustrated in FIG. 1 is applied, the femtosecond laser is expensive and thus the construction of such an imaging apparatus cannot be performed at low cost.

In contrast, in the case of constructing an image apparatus where the above method for generating a terahertz wave using the solid oscillator, the solid oscillator is cheaper than the femtosecond laser and small and thus the construction of such an imaging apparatus can be performed at low cost because the solid oscillator is cheaper than the femtosecond laser and small.

In the case of constructing an image apparatus where the above method for generating a terahertz wave using the solid oscillator, however, the terahertz wave is one in continuous wave form. Thus, the phase information of the object is hardly acquired even though the amplitude information of the object can be acquired.

For instance, to acquire the phase information of a terahertz wave passing through or reflecting from the object, it is considered that a terahertz wave is divided and one of the divided waves is used as a reference, while a pulse laser beam from a femtosecond layer is used as a probe beam to calculate a phase difference of the probe beam.

However, since the expensive femtosecond laser is used after all, the imaging apparatus cannot be constructed at low cost.

By the way, examples of the imaging apparatus using a terahertz wave include a scan-type imaging apparatus and a camera-type imaging apparatus.

Among them, for example, the scan-type imaging apparatus is constructed as illustrated in FIG. 1 and designed to acquire an image by two-dimensional scanning on an object.

This extends terahertz time domain spectroscopy, which is a typical spectroscopic spectrum measurement method using a terahertz wave, so that it can simultaneously determine the amplitude and the phase of a terahertz wave passing through (or reflecting from) each point of an object. Therefore, it is also possible to determine the distribution of physical properties, such as a complex index of refraction and a complex dielectric constant.

In addition, the camera-type imaging apparatus, for example one illustrated in FIG. 2, employs a visible or near-infrared layer beam as a probe beam and designed to capture the intensity distribution of a laser beam with a CCD camera or the like to acquire an image.

That is, the camera-type imaging apparatus irradiates terahertz waves passing through (or reflecting from) the object on an electro-optic crystal and the intensity distribution of a coaxially entered visible or near-infrared laser beam is then captured with a CCD camera or the like.

### SUMMARY

According to an aspect of the embodiment, an imaging apparatus includes an electromagnetic wave optical source configured to emit an electromagnetic wave in a continuous wave form, an electromagnetic wave dividing unit configured to divide the electromagnetic wave from the electromagnetic wave optical source into a first electromagnetic wave beam and a second magnetic wave beam, a probe optical source configured to emit a probe beam in a continuous wave form, a probe-beam dividing unit configured to divide the probe beam into a first probe beam and a second probe beam, a first electro-optic crystal on which the first electro-optic crystal is irradiated through an object and the first probe beam is incident, a second electro-optic crystal on which the second electro-optic crystal is irradiated through an object and the second probe beam is incident, an interference unit configured to allow the first probe beam from the first electro-optic crystal to interfere with the second probe beam from the second electro-optic crystal, and an image pickup device configured to capture an interference figure between the first probe beam and the second probe beam from the interference unit.

The object and advantages of the invention will be realized and attained by at least the features, elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a scan-type imaging apparatus;

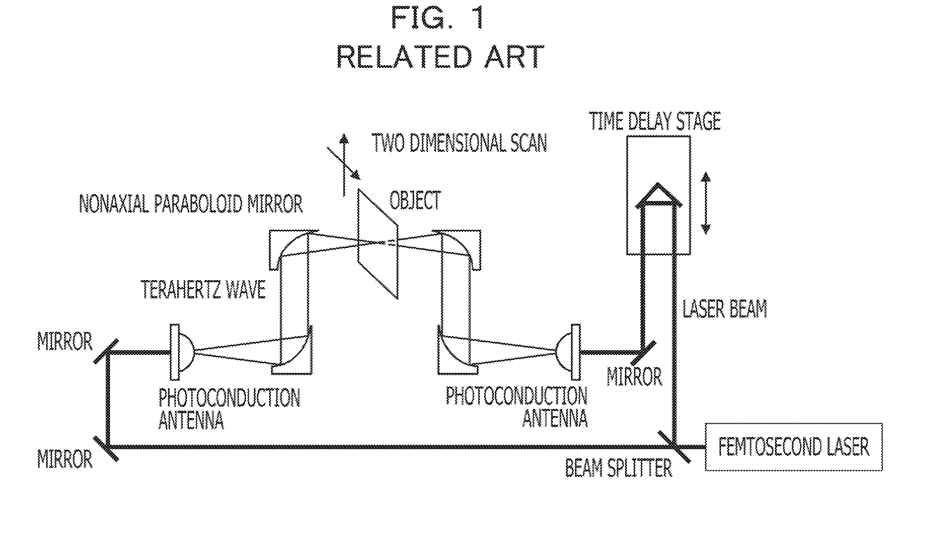

FIG. 2 is a schematic diagram illustrating a camera-type imaging apparatus;

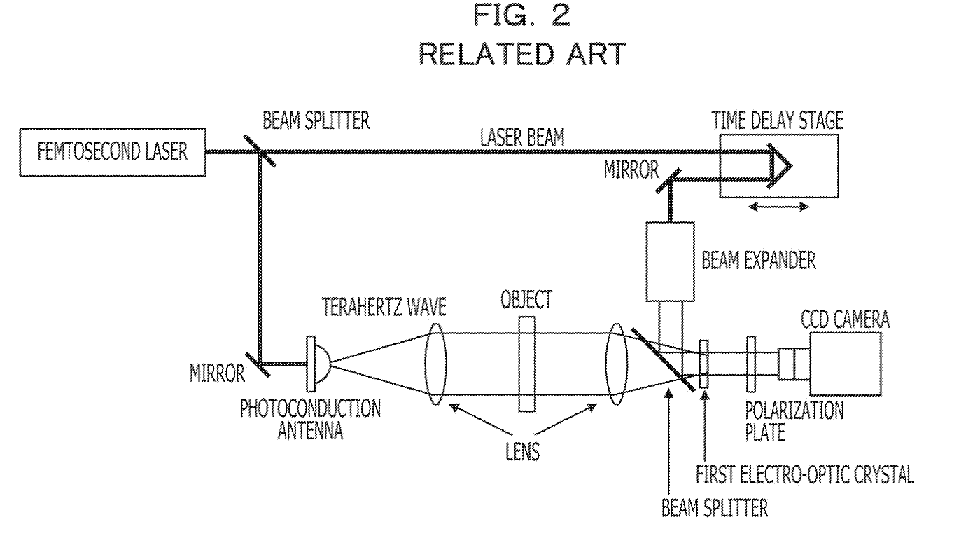

FIG. 3 is a schematic diagram illustrating an imaging apparatus of a first embodiment;

FIG. 4 is a schematic diagram illustrating the imaging apparatus of the first embodiment;

FIG. 5 is a schematic diagram illustrating an imaging apparatus of a second embodiment;

FIG. 6 is a schematic diagram illustrating the imaging apparatus of the second embodiment;

FIG. 7 is a schematic diagram illustrating a method for acquiring a phase image in the imaging apparatus of the second embodiment;

FIG. 8 is a schematic diagram illustrating an imaging apparatus of a third embodiment;

FIG. 9 is a schematic diagram illustrating the imaging apparatus of the third embodiment;

FIG. 10 is a flow chart illustrating a procedure of acquiring a phase image in the imaging apparatus of the third embodiment;

FIG. 11 is a schematic diagram illustrating an imaging apparatus of a fourth embodiment;

FIG. 12 is a schematic diagram illustrating the imaging apparatus of the fourth embodiment; and

FIG. 13 is a schematic diagram illustrating a modified example of the imaging apparatus of the second embodiment.

### DESCRIPTION OF EMBODIMENTS

A scanner imaging apparatus may be difficult to acquire an image within a short time because of two-dimensional scanning on an object.

The same applies to an imaging apparatus that employs an electromagnetic wave to visualize the inside of an object.

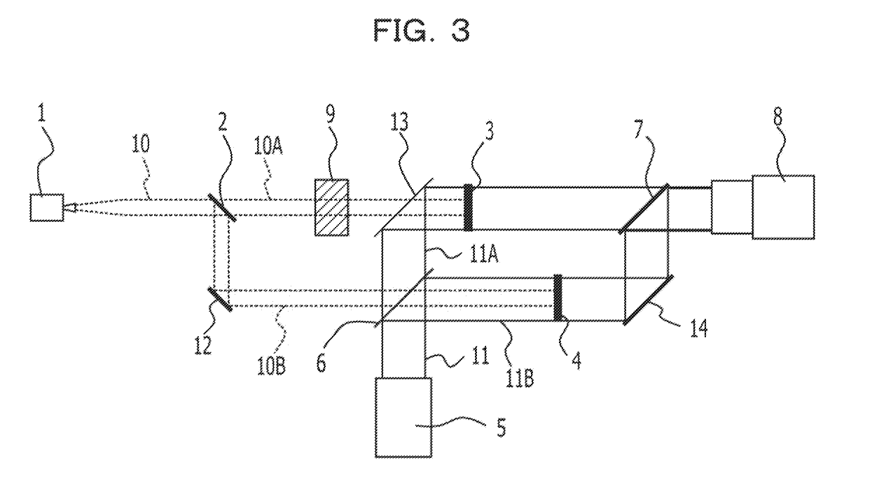

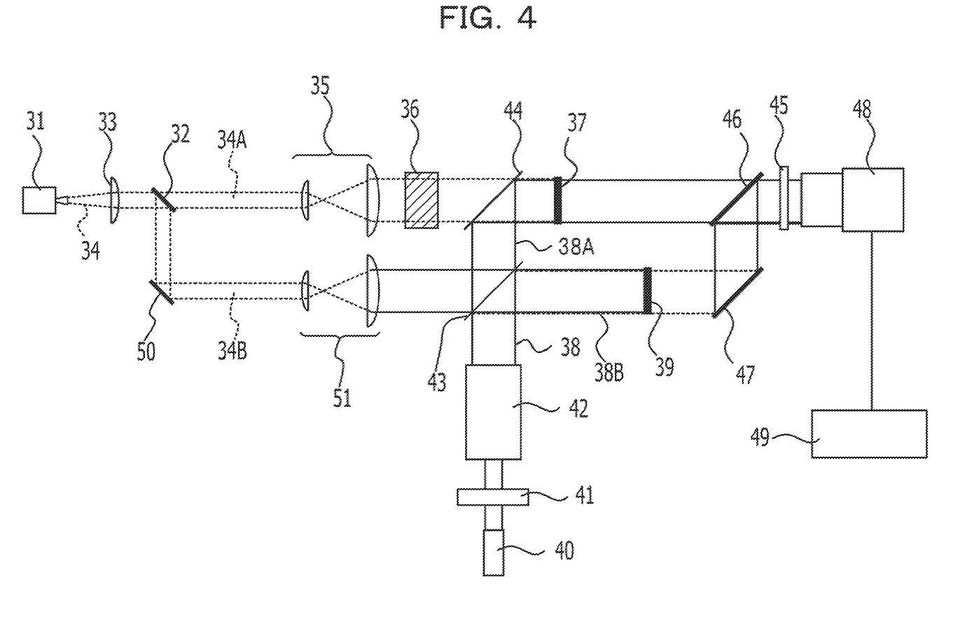

Referring now to FIG. 3 and FIG. 4, an imaging apparatus according to a first embodiment will be described.

The imaging apparatus of the first embodiment is an imaging apparatus that employs an electromagnetic wave to visualize the inside of an object. Here, such an imaging apparatus is also referred to as an object imaging apparatus.

In the first embodiment, the object imaging apparatus is a terahertz-wave imaging apparatus that visualizes the inside of an object using a terahertz wave.

As illustrated in FIG. 3, for example, the imaging apparatus of the first embodiment includes an electromagnetic wave optical source 1 for emitting an electromagnetic wave 10 in continuous wave form, a probe optical source 5 for emitting a probe beam 11 in the form of a continuous wave, a first electro-optic crystal 3, a second electro-optic crystal 4, and an image pickup device 8. Therefore, the imaging apparatus is a transmission type one using electromagnetic waves passing through an object 9.

Here, the electromagnetic wave optical source 1 is a terahertz optical source for emitting a terahertz wave in continuous wave form. Here, the term “terahertz wave” used herein refers to an electromagnetic wave with a frequency in the range of approximately 0.1 THz to 10 THz.

In the imaging apparatus of the first embodiment, a continuous electromagnetic wave 10 from the electromagnetic wave optical source 1 is divided into two beams 10A and 10B. One electromagnetic wave beam (first electromagnetic wave beam) 10A is irradiated on the first electro-optic crystal 3 through the object 9 and the other electromagnetic wave beam (second electromagnetic wave beam) 10B is irradiated on the second electro-optic crystal 4. Here, the first electro-optic crystal 3 is an imaging plate.

The imaging apparatus of the first embodiment includes a beam splitter 2 arranged between the electromagnetic wave optical source 1 and an area where the object 9 is placed. The beam splitter 2 is responsible for dividing the electromagnetic wave 10 from the electromagnetic wave optical source 1 into the first electromagnetic wave beam 10A and the second electromagnetic wave beam 10B.

The imaging apparatus also includes a mirror 12 for introducing the second electromagnetic wave beam 10B, which is divided from the beam splitter 2, to the second electro-optic crystal 4.

Here, the beam splitter 2 is also referred to as an electromagnetic wave dividing unit for dividing an electromagnetic wave 10 in continuous wave form from the electromagnetic wave optical source 1 into two beams 10A and 10B.

In the imaging apparatus of the first embodiment, a probe beam 11 in continuous wave form from the probe optical source 5 is divided into two beams 11A and 11B. Then, one probe beam (first probe beam) 11A is incident on the first electro-optical crystal 3 and the other probe beam (second probe beam 11B) is incident on the second electro-optic crystal 4.

The imaging apparatus of the first embodiment includes a beam splitter 13 for entering the first probe beam 11A into the first electro-optic crystal 3, coaxially with the first electromagnetic wave beam 10A. The beam splitter 13 is arranged between the first electro-optic crystal 3 and the area where the object 9 is placed and allows the first electromagnetic wave beam 10A to pass therethrough while reflecting the first probe beam 11A.

Furthermore, the imaging apparatus of the first embodiment includes a beam splitter 6 for entering the second probe beam 11B into the second electro-optic crystal 4, coaxially with the second electromagnetic wave beam 10B. The beam splitter 6 is arranged between the mirror 12 and the second electro-optic crystal 4 and allows the second electromagnetic wave beam 10B to pass therethrough while reflecting the second probe beam 11B. In this case, this imaging apparatus includes the beam splitter 6 between the probe optical source 5 and the first electro-optic crystal 3. The beam splitter 6 is responsible for dividing the probe beam 11 from the probe optical source 5 into the first probe beam 11A and the second probe beam 11B.

Here, the beam splitter 6 is also referred to as a probe-beam dividing unit for dividing the probe beam 11 in continuous wave form from the probe optical source 5 into two beams 11A and 11B.

Furthermore, the imaging apparatus of the first embodiment includes a beam splitter 7 for allowing the first probe beam 11A, which has passed through the first electro-optic crystal 3, and the second probe beam 11B, which has passed through the second electro-optic crystal 4, to interfere with each other. Here, the beam splitter 7 is arranged between the first electro-optic crystal 3 and the image pickup device 8 and allows the first probe beam 11A to pass therethrough while reflecting the second probe beam 11B. In other words, the beam splitter 7 is designed to output the first probe beam 11A from the first electro-optic crystal 3 and the second probe beam 11B from the second electro-optic crystal 4 coaxially with each other. Furthermore, the beam splitter 7 is also referred to as an interference unit for allowing the first probe beam 11A and the second probe beam 11B to interfere with each other.

Furthermore, the imaging apparatus of the first embodiment includes a mirror 14 for introducing the second probe beam 11B, which has passed through these second electro-optic crystal 4, to the beam splitter 7.

Furthermore, the image pickup device 8 captures an interference figure (interference fringe) between the first probe beam 11A and the second probe beam 11B from the beam splitter 7 served as an interference unit. Thus, an interference figure (image) including amplitude information and phase information can be obtained.

Therefore, the configuration of the imaging apparatus of the first embodiment has the advantage of being constructed at low cost while acquiring both the amplitude information and the phase information of the object 9 within a short time. Therefore, it is also possible to determine the distribution of physical properties, such as a complex refraction index and a complex dielectric constant.

In particular, there is an advantage in that the use of a terahertz wave (continuous wave) as an electromagnetic wave 10 (continuous wave) permits the measurement of two-dimensional distribution of the physical properties inherent to the terahertz region.

Hereafter, the imaging apparatus of the first embodiment will be described with reference to FIG. 4. In the first embodiment, for example as illustrated in FIG. 4, the imaging apparatus includes a Gunn diode 31 as a terahertz optical source for emitting a continuous terahertz wave 34, serving as an electromagnetic wave optical source 1 for emitting a continuous electromagnetic wave 10.

As a beam splitter 2, for example, a terahertz wave beam splitter 32 made of a Si wafer is included. For example, the beam splitter 32 is a high-resistance single-crystal Si wafer prepared by crystal growth by the floating zone (FZ) method and has substantially a constant transparency of approximately 50% at a region of approximately 0.3 THz to 12 THz when having a specific resistance of approximately 20 kΩ·cm and a thickness of approximately 1 mm. Therefore, the terahertz wave can be divided into one on the transparent side and the other on the reflection side at a ratio of 1:1.

The imaging apparatus includes a laser diode 40 for emitting a laser beam 38 in continuous wave form, which serves as a probe optical source 5 for emitting a probe beam 11 in continuous wave form. The laser beam 38 is a visible or near-infrared laser beam. Here, for example, the laser beam 38 has a wavelength of approximately 800 nm.

Pellicle beam splitters 43 and 44 are included as the beam splitters 6 and 13, respectively.

As first and second electro-optic crystals 3 and 4, for example, ZnTe crystals 37 and 39 with dimensions of approximately 30 mm×30 mm, a thickness of approximately 2 mm, and a plane direction of <110>, respectively. It is preferable that the ZnTe crystal 37 and the ZnTe crystal 39 are prepared so that their characteristics can be closely analogous to each other as much as possible.

A charge coupled device (CCD) camera 48 is included as an image pickup device 8. That is, the light intensity distribution of the interference figure of each of the first probe beam 38A and second probe beam 38B is captured by CCD camera 48. Here, the image pickup device 8 used is the CCD camera 48. However, it is not limited to the CCD camera 48. Alternatively, for example, it may be a complementary metal oxide semiconductor (CMOS) camera.

In the first embodiment, a polyethylene lens 33 is arranged between the Gunn diode 31 and terahertz-wave beam splitter 32. This polyethylene lens 33 is a collimate lens which collimates a terahertz wave 34 emitted from the Gunn diode 31. For example, the polyethylene lens 33 is designed to set the beam diameter of the terahertz wave 34 to about 10 mm.

In the first embodiment, the terahertz wave 34 in continuous wave form from the Gunn diode 31 is collimated with the polyethylene lens 33 and then incident on the terahertz-wave beam splitter 32. Subsequently, the terahertz-wave beam splitter 32 divides the terahertz wave 34 into two beams 34A and 34B. Here, one of them, the terahertz-wave beam 34A, is referred to as a first terahertz wave beam or a sample-side (object-side) terahertz wave beam. Furthermore, the other terahertz-wave beam 34B is referred to as a second terahertz wave beam or reference-side terahertz wave beam.

In the first embodiment, furthermore, a polyethylene lens system 35 is arranged between the terahertz-wave beam splitter 32 and the area where the object 36 is placed. Similarly, a polyethylene lens system 51 is arranged between a mirror 50 and the pellicle beam splitter 43. Here, these polyethylene lens systems 35 and 51 enlarge the beam diameters of the sample- and reference-side terahertz wave beams 34A and 34B to approximately 30 mm, respectively.

In the first embodiment, the sample-side terahertz wave beam 34A, which has passed through the terahertz-wave beam splitter 32, is irradiated on the object (sample) 36 after enlargement of its beam diameter with the polyethylene lens system 35. Subsequently, the sample-side terahertz wave beam 34A, which has passed through the object 36, passes through the pellicle beam splitter 44 and then irradiated on the ZnTe crystal (first electro-optic crystal) 37.

On the other hand, the reference-side terahertz wave beam 34B reflected from the terahertz-wave beam splitter 32 is reflected by the mirror 50 and its beam diameter is then enlarged by the polyethylene lens system 51, followed by passing to the pellicle beam splitter 43 and being irradiated on the ZnTe crystal (second electro-optic crystal) 39.

In the first embodiment, for example, a Berek compensator 41 and a beam expander 42 are arranged between the laser diode 40 and the pellicle beam splitter 43. For example, the beam expander 42 enlarges the beam diameter of the laser beam 38 emitted from the laser diode 40 to be substantially the same as or larger than the beam diameters of the sample- and reference-side terahertz wave beams 34A and 34B, which have been respectively enlarged by the polyethylene lens systems 35 and 51.

In the first embodiment, the laser beam 38 emitted from the laser diode 40 is incident on the beam expander 42 via the Berek compensator 41 and its beam diameter is then enlarged by the beam expander 42, followed by being incident on the pellicle beam splitter 43. Subsequently, the pellicle beam splitter 43 divides the laser beam 38 into two beams 38A and 38B. Here, one of them, a laser beam 38A, is referred to as a first laser (probe) beam or a sample-side laser (probe) beam. The other of them, a laser beam 38B, is referred to as a second laser (probe) beam or a reference-side laser (probe) beam.

Furthermore, the sample-side laser beam 38A, which has passed through the pellicle beam splitter 43, is reflected by the pellicle beam splitter 44 and then incident on the ZnTe crystal 37, coaxially with the sample-side terahertz wave beam 34A. On the other hand, the reference-side laser beam 38B reflected from the pellicle beam splitter 43 is incident on the ZnTe crystal 39, coaxially with the reference-side terahertz wave beam 34B.

When the terahertz wave beams 34A and 34B are respectively irradiated on the ZnTe crystals 37 and 39 as described above, according to the field strength of terahertz wave beams 34A and 34B, a Pockels effect produces birefringence in the ZnTe crystals 37 and 39 in response to the field strengths of the respective terahertz wave beams 34A and 34B. In other words, the field strength distributions of the terahertz wave beams 34A and 34B cause the birefringence distributions in the ZnTe crystals 37 and 39, respectively.

The polarization conditions of the laser (probe) beams 38A and 38B, which have passed through the ZnTe crystals 37 and 39, will be changed when birefringence occurs in the ZnTe crystals 37 and 39, respectively. In other words, the occurrence of birefringence distributions in the ZnTe crystals 37 and 39 cause distributions of polarization-state variations in the probe beams 38A and 38B, which have passed through the ZnTe crystals 37 and 39, respectively.

Therefore, when the probe beams 38A and 38B passes through the ZnTe crystals 37 and 39 on which the terahertz wave beams 34A and 34B have been irradiated, distributions of polarization-state variations will arise in the probe beams 38A and 38B in response to the field strength distributions of the terahertz wave beams 34A and 34B, respectively.

In other words, the sample-side probe beam 38A, which has been incident on the ZnTe crystal 37, will be modulated in response to the intensity distribution of the sample-side terahertz wave beam 34A irradiated on the ZnTe crystal 37. Also, the reference-side probe beam 38B, which has been incident on the ZnTe crystal 39, will be modulated in response to the intensity distribution of the reference-side terahertz wave beam 34B irradiated on the ZnTe crystal 39.

Especially the sample-side terahertz wave beam 34A passes through the object 36, thereby including the information on the object. That is, the field strength distribution of the sample-side terahertz wave beam 34A depends on the object 36. Therefore, the distributions of polarization-state variations in the sample-side terahertz wave beam 38A, which causes in response to the field strength distribution of the sample-side terahertz wave beam 34A, also depends on the object 36.

Here, the relationship of the intensity I(t) of the probe beam, which has been passed through the ZnTe crystal, with the intensity I₀(t) of the probe beam before transmission and the field strength E(t) of the terahertz wave can be represented by the following equations (1) and (2) (see, for example, A. Nahata et al., “Free-space electro-optic detection of continuous-wave terahertz radiation”, and Applied Refer to Physics Letters, Vol. 75, No. 17, and Oct. 25, 1999):

I(t)∝I₀(t)×E(t) (1)

I₀(t)×E(t)=I₀E_{T} cos(ωt+δ) cos Ωt (2)

Here, ω represents an angular frequency of the probe beam, Ω represents an angular frequency of the terahertz wave, δ represents a phase difference between the probe beam and the terahertz wave, and ET represents electric field amplitude.

In the first embodiment, the influence of a residual reflux index of each of the ZnTe crystals 37 and 39 is removed. For this purpose, for example, the Berek compensator 41 is arranged, and further, a polarization plate 45 is arranged in the direction perpendicular to the polarization direction of the probe light to detect the polarization-changing component of the probe beam. Here, the polarizing plate 45 is arranged between a beam splitter 46 and a CCD camera 48.

Therefore, only polarization-state changed components in the probe beams 38A and 38B can pass through the polarization plate 45. In other words, the polarization plate 45 can convert the distributions of polarization-state variations in the probe beams 38A and 38B into light intensity distribution by polarization plate 45. In particular, the distributions of polarization-state variations in the sample-side probe beam 38A depends on the object 36, so that the optical intensity distribution of the sample-side probe beam 38A can be one also depend on the object 36.

By the way, when the CCD camera 48 detects the intensity strength distribution of the sample-side terahertz wave beam 38A, which has been modified in response to the intensity distribution of the sample-side terahertz wave beam 34A irradiated on the ZnTe crystal 37, the amplitude information of the object 36 can be obtained but the phases information thereof cannot be obtained.

In other words, each pixel value of the CCD camera 48 is proportional to the result of integrating the intensity I of the probe beam reached on each pixel over the exposure time of the camera. Since the exposure time is set to be sufficiently longer than the frequencies of two sine terms in the above equation (2), an integral value does not depend on the phase difference δ of the probe beam and the terahertz wave. Therefore, the amplitude information of the object 36 can be obtained but the phase information cannot be obtained.

For this reason, the first embodiment provides the basic configuration of the imaging apparatus with additional components for reference as described above to obtain an interference figure including the amplitude information and the phase information of the object 36 by causing interference between the sample-side probe beam 38A and the reference-side probe beam 38B.

In other words, the first embodiment includes the Gunn diode 31, the polyethylene lens 33, the polyethylene lens system 35, the laser diode 40, the Berek compensator 41, the beam expander 42, the beam splitter 44, the first electro-optic crystal 37, the polarizing plate 45, and the CCD camera 48.

Furthermore, the first embodiment includes the reference components: the beam splitter 32, the mirror 50, the polyethylene lens system 51, the beam splitter 43, the second electro-optic crystal 39, the mirror 47, and the beam splitter 46.

The beam splitter 46 places the reference-side probe beam 38B, which has been modulated by the ZnTe crystal 39, over the sample-side probe beam 38A, which has been modulated by the ZnTe crystal 37, coaxially with each other to cause interference between them. In this case, it is preferable that the distance from the ZnTe crystal 37 to the beam splitter 46 substantially coincides with the distance from the ZnTe crystal 39 to the beam splitter 46 via a reflector 47.

Then, the CCD camera 48 captures an interference figure (interference fringe) produced by the interference between the sample-side probe beam 38A and the reference-side probe beam 38B. Therefore, the interference figure including the amplitude information and the phase information of the object 36 can be acquired.

In the first embodiment, the CCD camera 48 is connected to a computer (control/arithmetic processing unit) 49, so that the interference figure acquired by the CCD camera 48 can be displayed as an image on a display unit of the computer 49.

The CCD camera 48 is preferably one which acts at a comparatively high rate, for example at a rate of 1,000 frame/s. In addition, the power of the Gunn diode 31 is preferably modified using an output modulator or an optical chopper (not shown) to synchronize with the CCD camera 48.

Therefore, according to the configuration of the imaging apparatus of the first embodiment, the apparatus can be constructed at low cost. In addition, it permits the acquisition of phase information. Furthermore, the high-speed CCD camera is used for image capturing, so that an image can be acquired almost in real time. Thus, a time required for acquiring an image (image-capturing time) can be shortened.

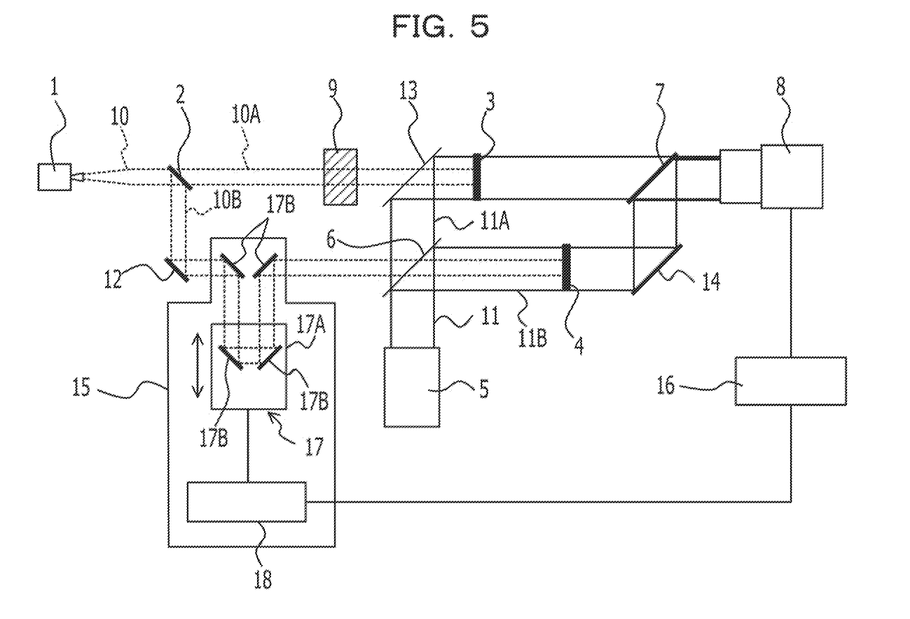

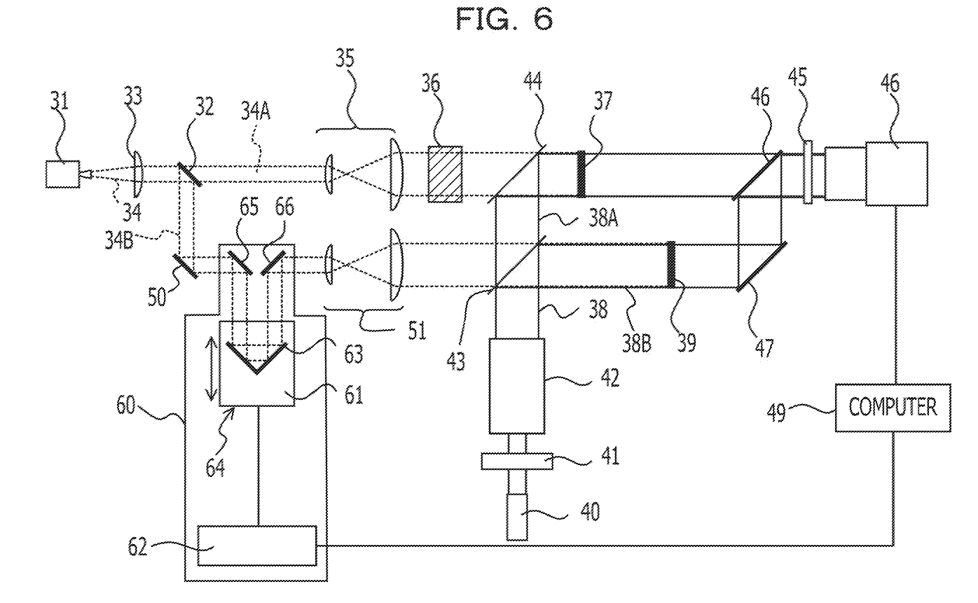

Referring now to FIG. 5 and FIG. 6, an image apparatus according to a second embodiment will be described.

The imaging apparatus of the second embodiment is different from that of the aforementioned first embodiment (see FIG. 3) in that the former is designed to acquire a plurality of interference figures by changing a phase difference between a first electromagnetic wave beam 10A and a second electromagnetic wave beam 10B and then acquire a phase image from the plurality of interference figures.

Thus, as shown in FIG. 5, the imaging apparatus of the second embodiment includes a time delay unit 15 for causing a time delay of the second electromagnetic wave beam 10B with respect to the first electromagnetic wave beam 10A and a control/arithmetic processing unit 16 for acquiring a phase image from a plurality of interference figures captured by a image pickup device 8 while changing an amount of time delay with the time delay unit 15. In FIG. 5, the same structural components as those of the aforementioned first embodiment (see FIG. 3) are designated by the same reference numerals.

Here, the time delay unit 15 includes a time delay mechanism 17 having a stage 17A and a mirror 17B, a time delay mechanism controller 18 for controlling the time delay mechanism 17. The time delay unit 15 is installed in an optical path along with the second electromagnetic wave beam 10B passes.

The control/arithmetic processing unit 16 is a computer or the like. Here, the computer 16 includes a display unit, a storage unit, and the like.

Furthermore, based on instructions from the control/arithmetic processing unit 16, the time delay mechanism controller 18 controls the time delay mechanism 17. In other words, the amount of time delay with the time delay mechanism 17 is under the control of the control/arithmetic processing unit 16.

Furthermore, based on the instructions from the control/arithmetic processing unit 16, the timing of image capturing by an image pickup device 8 is controlled. In other words, the control/arithmetic processing unit 16 is designed to control the image pickup device 8 to capture an interference figure while controlling the time delay unit 15 to change the amount of time delay. In this case, the amount of time delay is changed by the time delay mechanism 17, while the image pickup device 8 captures a plurality of interference figures. Then, the control/arithmetic processing unit 16 acquires a phase image from a plurality of interference figures captured by the image pickup device 8. In this way, by acquiring the plurality of interference figures while changing the phase difference, a phase image can be acquired in addition to a phase image.

In the second embodiment, for example, the control/arithmetic processing unit 16 is designed to control the amount of time delay with the time delay unit 15, so that the phase difference between the first electromagnetic wave beam 10A and the second electromagnetic wave beam 10B can be set to 0 (zero), π/2, π, or 3π/2. In this way, by setting the phase difference between the first electromagnetic wave beam 10A and the second electromagnetic wave beam 10B to 0 (zero), π/2, π, or 3π/2, an image-capturing time can be shortened without losing phase information.

Since other details are substantially the same as those of the aforementioned first embodiment, the description thereof will be omitted.

Therefore, according to the configuration of the imaging apparatus of the second embodiment, both the amplitude information and the phase information of the object 9 can be shortened and the apparatus can be constructed at low cost. Therefore, it is also possible to determine the distribution of physical properties, such as a complex refraction index and a complex dielectric constant.

In particular, there is an advantage in that the use of a terahertz wave (continuous wave) as an electromagnetic wave 10 (continuous wave) permits the measurement of two-dimensional distribution of the physical properties inherent to the terahertz region.

In addition, there is an advantage in that the acquisition of phase information becomes possible.

Hereafter, the imaging apparatus of the second embodiment will be described with reference to FIG. 6.

The configuration of the imaging apparatus according to the second embodiment is different from that of the aforementioned first embodiment (see FIG. 4) in that the former includes a time delay unit 60 as illustrated in FIG. 6.

In the second embodiment, the time delay unit 60 includes: a time delay mechanism 64 having two mirrors 65 and 66, a linear stage 61, and a retro-reflector 63 mounted on the linear stage 61; a stage controller (stage control device) 62 for controlling the position of the linear stage 61.

In the second embodiment, two mirrors 65 and 66 are arranged between the mirror 50 and the polyethylene lens system 51. Then, a reference-side terahertz wave beam 34B from the mirror 50 is reflected by the mirror 65 and then introduced to the retro-reflector 63. In addition, the reference-side terahertz wave beam 34B reflected from the retro-reflector 63 is reflected by the mirror 66 and then incident on the polyethylene lens system 51. Under the circumstances, based on instructions from the computer 49 as a control/arithmetic processing unit 16, the stage controller 62 controls the position of the linear stage 61 to control the amount of time delay of the reference-side terahertz wave beam 34B. In other words, the position of the retro-reflector 63 is changed by changing the position of the linear stage 61 to adjust the distance between two mirrors 65 and 66 and the retro-reflector 63, thereby adjusting the time delay of the reference-side terahertz wave beam 34B.

In the second embodiment, for example, the amount of time delay of the reference-side terahertz wave beam 34B with respect to the sample-side terahertz wave beam 34A is adjusted, so that the phase difference between the sample-side terahertz wave beam 34A and the reference-side terahertz wave beam 34B can be set to 0 (zero), π/2, π, or 3π/2. In other words, the position of the linear stage 61 is controlled stepwise to change stepwise the position of the retro-reflector 63, so that the phase difference between the sample-side terahertz wave beam 34A and the reference-side terahertz wave beam 34B can be 0 (zero), π/2, π, or 3π/2.

Then, the CCD camera 48 is designed to capture an interference figure (interference fringe image) when the phase difference between the sample-side terahertz wave beam 34A and the reference-side terahertz wave beam 34B can be each of 0 (zero), π/2, π, and 3π/2.

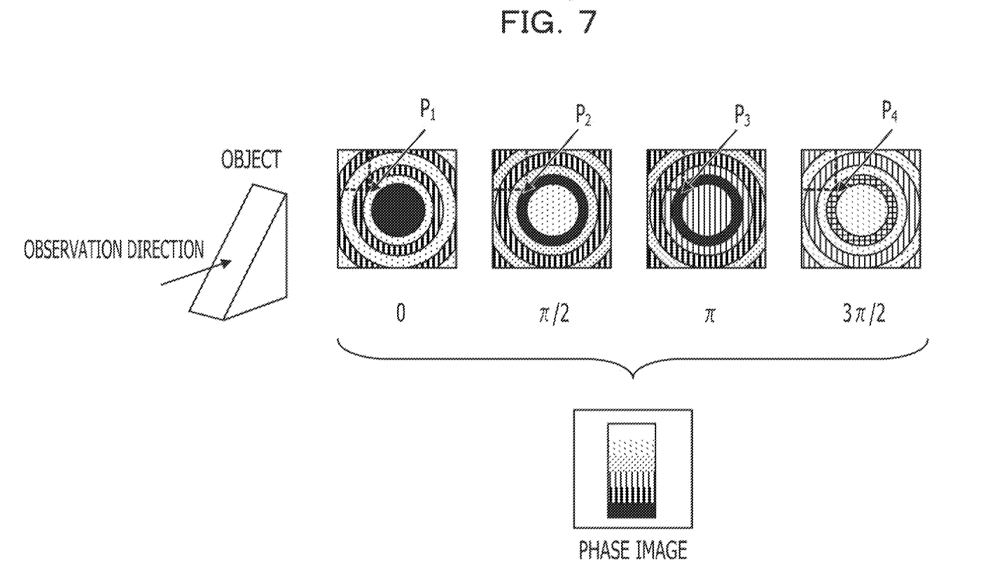

For four interference figures captured in this way (see FIG. 7), if gradation values of a certain pixel are defined as P₁, P₂, P₃, and P₄, the phase φ of the pixel can be calculated using the following equation (3):

φ=tan⁻¹ {(P₂−P₄)/(P₃−P₄)} (3)

Therefore, the computer 49 can calculate all the pixels using this calculation and the phase image of the object 36 can be acquired as illustrated in FIG. 7.

Since 2πN(N is an integer) may be defined arbitrarily, it is preferable to carry out a phase connection (phase unwrapping) process if needed. For example, it is preferable to carry out a process for adjusting the integer N so that the phase difference between the adjacent pixels can fall within the range of ±π.

Furthermore, other details are substantially the same as those of the aforementioned first embodiment, so that the detailed description thereof will be omitted herein.

Therefore, according to the configuration of the imaging apparatus of the second embodiment, the apparatus can be constructed at low cost. In addition, it permits the acquisition of a phase image. Furthermore, the high-speed CCD camera 48 is used for image capturing, so that an image can be acquired almost in real time. Thus, a time required for acquiring an image (image-capturing time) can be shortened even if a plurality of images is obtained while changing the phase by the time delay unit 60. Furthermore, a further reduction in image-capturing time is possible when the amount of time delay is changed in four steps.

The aforementioned second embodiment is designed to provide one of the electromagnetic wave beam (terahertz wave beam) with time delay, but not limited thereto. Alternatively, for example, time delay may be applied to one of probe beams which have passed through two electro-optic crystals (ZnTe crystals). In this case, preferably, the control/arithmetic processing unit 16 (49) may control the amount of time delay by the time delay unit 15 (60) so that the phase difference between the first probe beam 11A (38A) and the second probe beam 11B (38B) will be set to, for example, 0, π/2, π, or 3π/2. For example, the same time delay unit as one described above may be arranged between the second electro-optic crystal 4 (ZnTe crystal 39) and the mirror 14 (47).

In the aforementioned second embodiment, the time delay unit 15 is arranged on the side of the second electromagnetic wave beam 10B and the second electromagnetic wave beam 10B is time-delayed with respect to the first electromagnetic wave beam 10A. However, the second embodiment is not limited to these configurations. For example, a time delay unit may be formed on the side of the first electromagnetic wave beam 10A and the first electromagnetic wave beam 10A may be time-delayed with respect to the second electromagnetic wave beam 10B. In other words, the time delay unit may be formed to cause time delay of one of the first and second electromagnetic wave beams 10A and 10B.

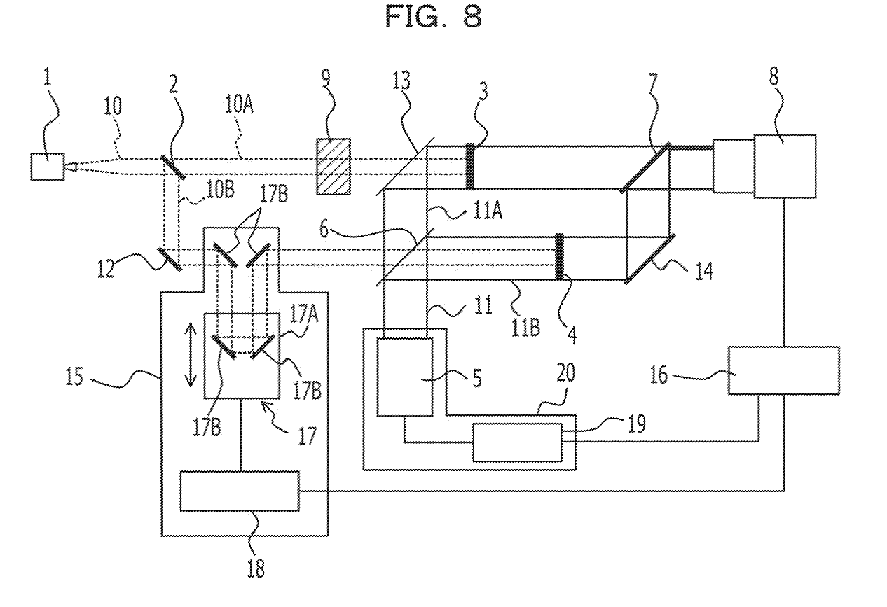

Referring now to FIGS. 8 to 10, an imaging apparatus according to a third embodiment will be described.

The imaging apparatus of the third embodiment is different from that of the aforementioned second embodiment (see FIG. 5) in that the former is designed to provide a probe optical source 5 for continuous waves with a wavelength conversion unit 19 for changing the wavelength of a probe beam 11 so that an interference figure can be captured using at least two wavelengths. In FIG. 8, the same structural components as those of the aforementioned second embodiment (see FIG. 5) are designated by the same reference numerals.

In other words, the imaging apparatus of the third embodiment includes a wavelength-variable probe optical source 20 composed of the wavelength the probe optical source 5 for continuous waves and the wavelength conversion unit 19 for changing the wavelength of the probe beam 11.

Furthermore, in the imaging apparatus of the third embodiment, the control/arithmetic processing unit 16 is designed to acquire one phase image from a plurality of phase images acquired from a plurality of interference figures captured by an image pickup device 8 while changing the wavelength of a probe beam 11 from the wavelength-variable probe optical source 20.

In other words, in response to instructions from the control/arithmetic processing unit 16, the wavelength conversion unit 19 for changing the wavelength of the probe beam 11 controls the wavelength of the probe beam 11 emitted from the probe optical source 5. In other words, the control/arithmetic processing unit 16 is designed to control the wavelength of the probe beam 11 emitted from the wavelength-variable probe optical source 20.

Furthermore, based on the instructions from the control/arithmetic processing unit 16, the timing of image capturing by an image pickup device 8 is controlled. In other words, the control/arithmetic processing unit 16 is designed to control the image pickup device 8 to capture an interference figure while controlling the change of the wavelength of the probe beam 11 emitted from the wavelength-variable probe optical source 20. In this case, a plurality of interference figures will be captured by the image pickup device 8 for every probe beams 11 of different wavelengths. Then, the control/arithmetic processing unit 16 may acquire a phase image from a plurality of interference figures obtained for every probe beam 11 of different wavelengths to acquire one phase image from a plurality of phase images obtained as described above.

In this case, every time the wavelength of the probe beam 11 is changed, a phase image can be obtained for every probe beam 11 of different wavelengths by acquiring a plurality of interference figures while changing the phase difference. Then, one phase image can be acquired from a plurality of phase images obtained in this way.

Since other details are the same as those of the aforementioned second embodiment, the description thereof will be omitted.

Therefore, according to the configuration of the imaging apparatus of the third embodiment, both the amplitude information and the phase information of the object 9 can be shortened and the apparatus can be constructed at low cost. Therefore, it is also possible to determine the distribution of physical properties, such as a complex refraction index and a complex dielectric constant.

In particular, there is an advantage in that the use of a terahertz wave (continuous wave) as an electromagnetic wave 10 (continuous wave) permits the measurement of two-dimensional distribution of the physical properties inherent to the terahertz region.

In addition, there is an advantage in that the acquisition of phase information becomes possible. Furthermore, since a plurality of phase images can be acquired using probe beams 11 of different wavelengths, there is an advantage in that the use of these phase images enables the acquisition of a more precise phase image.

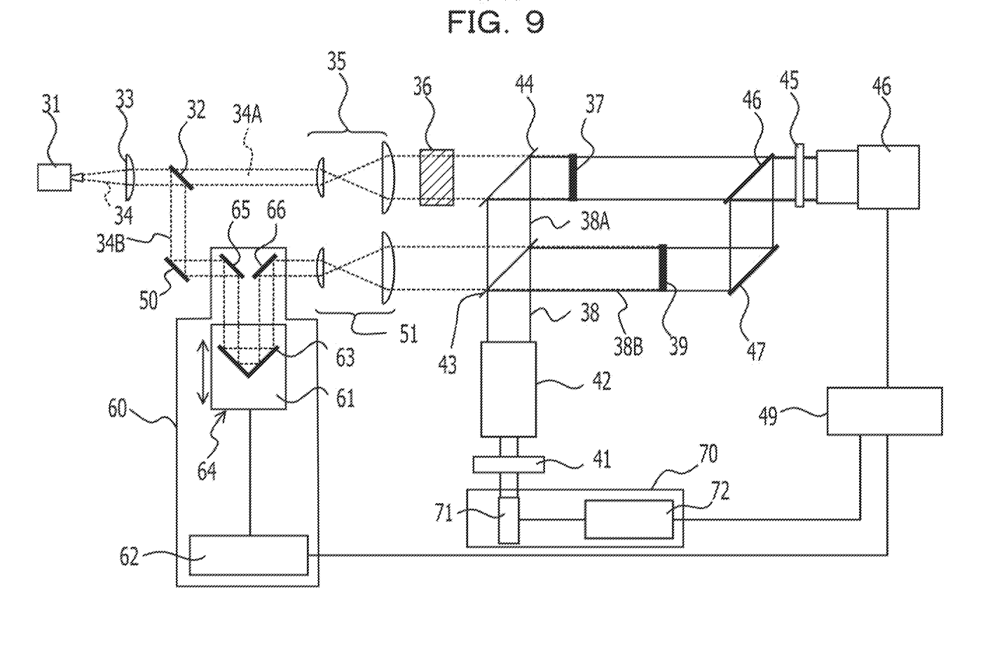

Hereafter, the imaging apparatus of the third embodiment will be described with reference to FIG. 9.

As illustrated in FIG. 9, the third embodiment is different from the aforementioned second embodiment (see FIG. 6) in that the former includes a wavelength-variable titanium sapphire laser 71 and a wavelength-variable probe optical source 70 with a wavelength controller 72.

In other words, the imaging apparatus of the third embodiment includes the wavelength-variable titanium sapphire laser 71 as a probe optical source 5 for continuous waves and the wavelength controller 72 as a wavelength conversion unit 19 for changing the wavelength of the probe beam 11.

Furthermore, the wavelength controller 72 controls the wavelength-variable titanium sapphire laser 71 based on instructions from a computer 49 as a control/arithmetic processing unit 16, enabling a change in wavelength of the laser beam (probe beam) 38. In other words, the computer 49, which serves as a control/arithmetic processing unit 16, controls the wavelength of a laser beam 38 emitted from the wavelength-variable laser optical source 70.

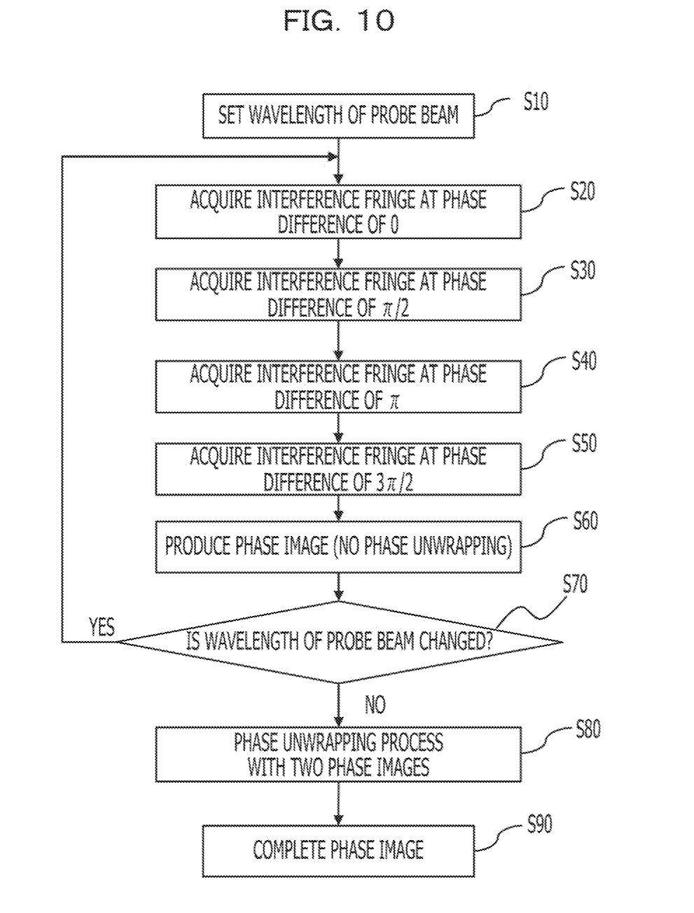

Hereafter, the control procedure of the third embodiment will be described with reference to FIG. 10.

The wavelength controller 72 controls the wavelength-variable titanium sapphire laser 71 based on instructions from the computer 49 to set the wavelength of the probe beam 38 to λ1 (for example, 750 nm) (S10).

An amount of time delay is controlled so that the phase difference between the sample-side terahertz wave beam 34A and the reference-side terahertz wave beam 34B is set to zero (0) (S20). In other words, the stage controller 62 controls the position of the linear stage 61 based on instructions from the computer 49. Therefore, the position of the retro-reflector 63 is changed and the amount of time delay of the reference-side terahertz wave beam 34B is adjusted to set the phase difference between the sample-side terahertz beam 34A and the reference-side terahertz wave beam 34B to zero (0).

An interference figure between the sample-side terahertz wave beam 34A and the reference-side terahertz wave beam 34B is captured by the CCD camera 48 under the state where the phase difference between the sample-side terahertz wave beam 34A and the reference-side terahertz wave beam 34B (S20). In other words, based on instructions from the computer 49, the CCD camera 48 captures the interference figure between the sample-side terahertz wave beam 34A and the reference-side terahertz wave beam 34B. Thus, the interference figure captured when the phase difference is zero (0) is transferred from the CCD camera 48 to the computer 49. Therefore, the computer 49 acquires an interference image when the phase difference is zero (0) (S20).

The amount of time delay is controlled so that the phase difference between the sample-side terahertz wave beam 34A and the reference-side terahertz wave beam 34B can be set to π/2 (S30). In other words, the stage controller 62 controls the position of the linear stage 61 based on instructions from the computer 49. Therefore, the position of the retro-reflector 63 is changed and the amount of time delay of the reference-side terahertz wave beam 34B is adjusted, so that the phase difference between the sample-side terahertz wave beam 34A and the reference-side terahertz can be set to π/2.

In this way, furthermore, the CCD camera 48 captures an interference figure between the sample-side terahertz wave beam 34A and the reference-side terahertz wave beam 34B under the state where the phase difference between the sample-side terahertz wave beam 34A and the reference-side terahertz wave beam 34B is being set to π/2 (S30). In other words, the CCD camera 48 captures the interference figure between the sample-side terahertz wave beam 34A and the reference-side terahertz wave beam 34B based on instructions from computer 49. Thus, the interference figure with a captured phase difference of π/2 is transferred from the CCD camera 48 to the computer 49. Therefore, the computer 49 acquires the interference figure with a phase difference π/2 (S30).

The amount of time delay is controlled so that the phase difference between the sample-side terahertz wave beam 34A and the reference-side terahertz wave beam 34B can be set to π (S40). In other words, the stage controller 62 controls the position of the linear stage 61 based on instructions from the computer 49. Therefore, the position of the retro-reflector 63 is changed and the amount of time delay of the reference-side terahertz wave beam 34B is adjusted, so that the phase difference between the sample-side terahertz wave beam 34A and the reference-side terahertz can be set to π.

In this way, furthermore, the CCD camera 48 captures an interference figure between the sample-side terahertz wave beam 34A and the reference-side terahertz wave beam 34B under the state where the phase difference between the sample-side terahertz wave beam 34A and the reference-side terahertz wave beam 34B is being set to π (S40). In other words, the CCD camera 48 captures the interference figure between the sample-side terahertz wave beam 34A and the reference-side terahertz wave beam 34B based on instructions from computer 49. Thus, the interference figure captured when the phase difference is π is transferred from the CCD camera 48 to the computer 49. Therefore, the computer 49 acquires the interference figure with a phase difference π (S40).

The amount of time delay is controlled so that the phase difference between the sample-side terahertz wave beam 34A and the reference-side terahertz wave beam 34B can be set to 3π/2 (S50). In other words, the stage controller 62 controls the position of the linear stage 61 based on instructions from the computer 49. Therefore, the position of the retro-reflector 63 is changed and the amount of time delay of the reference-side terahertz wave beam 34B is adjusted, so that the phase difference between the sample-side terahertz wave beam 34A and the reference-side terahertz can be set to 3π/2.

In this way, furthermore, the CCD camera 48 captures an interference figure between the sample-side terahertz wave beam 34A and the reference-side terahertz wave beam 34B under the state where the phase difference between the sample-side terahertz wave beam 34A and the reference-side terahertz wave beam 34B is being set to 3π/2 (S50). In other words, the CCD camera 48 captures the interference figure between the sample-side terahertz wave beam 34A and the reference-side terahertz wave beam 34B based on instructions from computer 49. Thus, the interference figure with a captured phase difference of 3π/2 is transferred from the CCD camera 48 to the computer 49. Therefore, the computer 49 acquires the interference figures with a phase difference 3π/2 (S50).

Therefore, the computer 49 acquires interference figures for the respective phases differences of 0, π/2, π, and 3π/2 and a phase image is then generated from these four interference figures without performing a phase unwrapping process (S60).

The computer 49 determines whether the wavelength of the probe beam 38 is changed or not (S70).

Here, it is determined that the wavelength of the probe beam 38 is changed.

Then, based on instructions from the computer 49, the wavelength controller 72 controls the wavelength-variable titanium sapphire laser 71 to change the wavelength of the probe beam 38 to λ₂ (for example, 850 nm).

Then, the process returns to S20 and the procedures from S20 to S60 are repeated.

In other word, the same procedures as those of the above steps S20 to S60, the interference figures for the respective phase differences of 0, π/2, π, and 3π/2 are acquired and a phase image is then generated from these four interference figures without performing a phase unwrapping process.

The computer 49 determines whether the wavelength of the probe beam 38 is changed or not (S70).

Here, it is determined that the wavelength of the probe beam 38 is changed. Then, the process proceeds to S80 and the computer 49 performs a phase unwrapping process to generate one phase image from two phase images obtained using the probe beams 38 of different wavelengths (S90). In other words, when changing the wavelength of the probe beam 38, an interference fringe will be generated at a different position even if the phase differences are equal to each other. Therefore, one phase image is acquired by performing a phase unwrapping process on two phase images obtained from interference fringes generated at different positions. Thus, by acquiring the phase image in this way, a more precise phase image is acquirable.

Furthermore, other details are the same as those of the aforementioned second embodiment, so that the detailed description thereof will be omitted herein.

Therefore, according to the configuration of the imaging apparatus of the third embodiment, the apparatus can be constructed at low cost. In addition, it permits the acquisition of a phase image. Furthermore, the high-speed CCD camera 48 is used for image capturing, so that an image can be acquired almost in real time. Thus, a time required for acquiring an image (image-capturing time) can be shortened even if a plurality of images is obtained while changing the phase by the time delay unit 60. Furthermore, for example, a further reduction in image-capturing time is possible when the amount of time delay is changed in four steps. Furthermore, since a plurality of phase images can be acquired using probe beams 38 of different wavelengths, there is an advantage in that the use of these phase images enables the acquisition of a more precise phase image.

Although the above third embodiment has been described as a modified example of the above second embodiment, the third embodiment is not limited thereto. Alternatively, for example, it may be configured as a modified example of the above first embodiment.

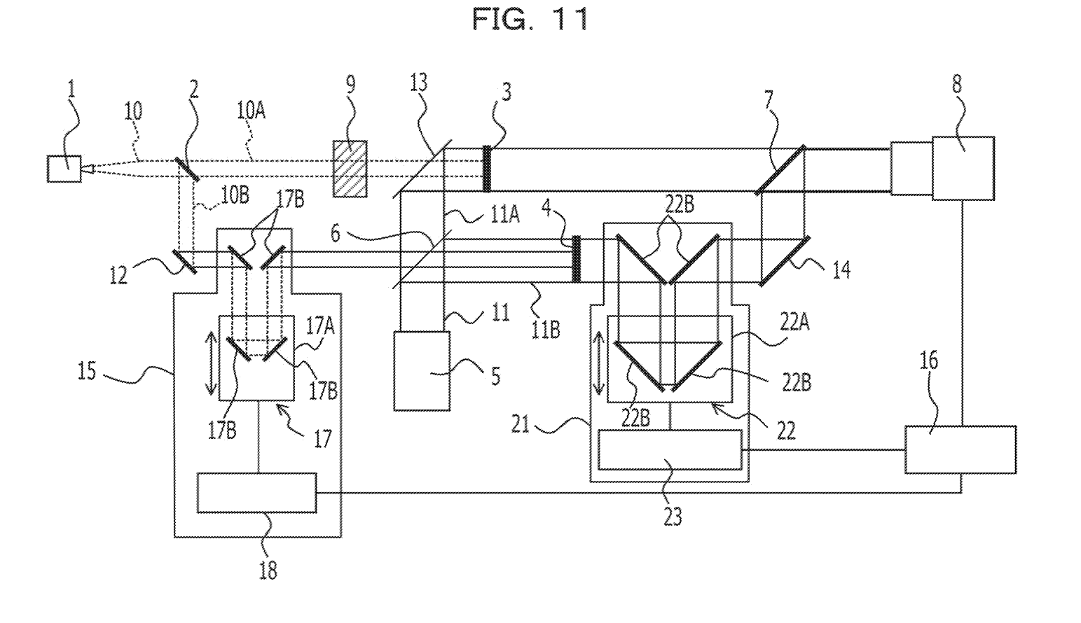

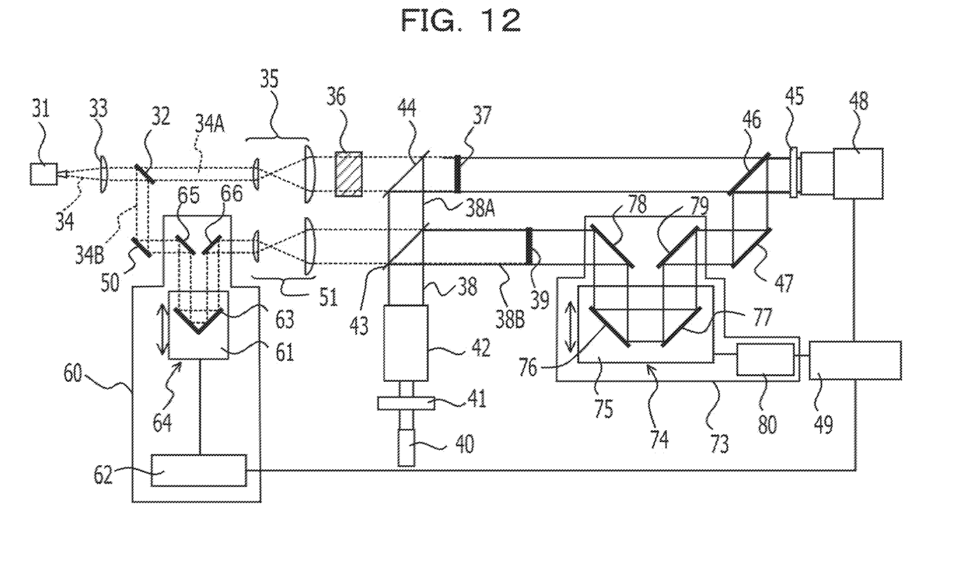

Referring now to FIG. 11 and FIG. 12, an imaging apparatus according to a fourth embodiment will be described.

The imaging apparatus of the fourth embodiment is different from that of the aforementioned second embodiment (see FIG. 5) in that the former is designed to be capable of adjusting an optical path length difference between probe beams 11A and 11B by adjusting the optical path length of the first probe beam 11A and the optical path length of the second probe beam 11B.

Therefore, as shown in FIG. 11, the imaging apparatus of the fourth embodiment is different from that of the aforementioned second embodiment (see FIG. 11) in that an optical path length adjusting unit 21 is provided for adjusting an optical path length between the second electro-optic crystal 4 and the image pickup device 8 with respect to an optical path length between the first electro-optic crystal 3 and the image pickup device 8. In FIG. 11, the same structural components as those of the aforementioned second embodiment (see FIG. 5) are designated by the same reference numerals.

Here, the optical path length adjusting unit 21 includes an optical path length adjusting mechanism 22 having a stage 22A and a mirror 22B and a controller 23 for optical path length adjusting mechanism, which controls the optical path length adjusting mechanism. The optical path length adjusting unit 21 is installed in an optical path along with the second probe beam 11B passes.

Furthermore, based on instructions from the control/arithmetic processing unit 16, the controller 23 for optical path length adjusting mechanism controls the optical path length adjusting mechanism 22. In other words, an adjusting amount of optical path length with the optical path length adjusting mechanism 22 is under the control of the control/arithmetic processing unit 16.

Since other details are the same as those of the aforementioned second embodiment, the description thereof will be omitted.

Therefore, according to the configuration of the imaging apparatus of the fourth embodiment, both the amplitude information and the phase information of the object 9 can be shortened and the apparatus can be constructed at low cost. Therefore, it is also possible to determine the distribution of physical properties, such a complex refraction index and a complex dielectric constant.

In particular, there is an advantage in that the use of a terahertz wave (continuous wave) as an electromagnetic wave 10 (continuous wave) permits the measurement of two-dimensional distribution of the physical properties inherent to the terahertz region.

In addition, there is an advantage in that the acquisition of phase information becomes possible.

Furthermore, there is an advantage in that a more precise and stable phase image can be acquired as a result of obtaining a more precise interference figure by finely adjusting the optical path lengths of two probe beams 11A and 11B to be interfered with each other.

Hereafter, the imaging apparatus of the fourth embodiment will be described with reference to FIG. 12.

The configuration of the imaging apparatus according to the fourth embodiment is different from that of the aforementioned second embodiment (see FIG. 6) in that the former includes an optical path length adjusting unit 73 as illustrated in FIG. 6.

In other words, in the fourth embodiment, the optical path length adjusting unit 73 includes: two mirrors 78 and 79; an optical path length adjusting mechanism 74 having a piezo stage 75 and two mirrors (reflectors) 76 and 77 arranged on the piezo stage 75; and a stage controller (stage control device) 80 for controlling the position of the piezo stage 75.

In the fourth embodiment, two mirrors 78 and 79 are arranged between a ZnTe crystal (second electro-optic crystal) 39 and the mirror 47. Then, a reference-side probe optical beam 38B from the ZnTe crystal 39 is reflected by the mirror 78 and then introduced to the mirrors 76 and 77 on the piezo stage 75. In addition, the reference-side probe beam 38B, which is reflected from the mirrors 76 and 77 on the piezo stage 75, is reflected by the mirror 79 and then introduced to the mirror 47. Under the circumstances, based on instructions from the computer 49 as a control/arithmetic processing unit 16, the stage controller 80 controls the position of the piezo stage 75 to control an adjusting amount of optical path length of the reference-side probe beam 38B. In other words, by changing the position of the piezo stage 75, the positions of two mirrors 76 and 77 are changed to adjust the distances between two mirrors 78 and 79 and two mirrors 76 and 77 on the piezo stage 75, respectively, thereby adjusting the optical path length of the reference-side probe beam 38B.

Therefore, the optical path length until the probe beams 38A and 38B, which have passed through two electro-optical crystals 37 and 39, are interfered with each other can be finely adjusted.

Furthermore, other details are the same as those of the aforementioned second embodiment, so that the detailed description thereof will be omitted herein.

Therefore, according to the configuration of the imaging apparatus of the fourth embodiment, the apparatus can be constructed at low cost. In addition, it permits the acquisition of a phase image. Furthermore, the high-speed CCD camera 48 is used for image capturing, so that an image can be acquired almost in real time. Thus, a time required for acquiring an image (image-capturing time) can be shortened even if a plurality of images is obtained while changing the phase by the time delay unit 60. Furthermore, a further reduction in image-capturing time is possible when the amount of time delay is changed in four steps. The optical path lengths of two probe beams 38A and 38B to be interfered with each other can be finely adjusted. Thus, it is possible to prevent a shift in interference fringe to be caused by an unintended small shift of the optical path occurred in two probe beams 38A and 38B. Therefore, there is an advantage in that a more precise and stable interference figure is obtained and, as a result, a more precise and stable phase image can be acquired.

The above fourth embodiment has been described as a modified example of the above second embodiment, but not limited thereto.

Alternatively, for example, it may be configured as a modified example of the above first or third embodiment. In the aforementioned fourth embodiment, the optical path length adjusting unit 21 is arranged on the side of the second probe beam 11B and the optical path length of the second probe beam 11B is adjusted with respect to the first probe beam 11A. However, the fourth embodiment is not limited to these configurations. For example, the optical path length adjusting unit 21 may be formed on the side of the first probe beam 11A and the optical path length of the first probe beam 11A may be time-delayed with respect to the second probe beam 11B. In other words, the optical path length adjusting unit 21 may be provided for adjusting an optical path length of the first probe optical beam 11A or the second probe optical beam 11B. That is, an optical path length between the first electro-optic crystal 3 and the image pickup device 8 or an optical path length between the second electro-optic crystal 4 and the image pickup device 8 may be adjusted.

Furthermore, the present invention is not limited to the configurations, conditions, and so on specifically described in the respective embodiments as described above. Various modifications may occur without departing from the gist of the present invention.

For example, each of the above embodiment has been described with reference to an example in which a Gunn diode is used as a terahertz continuous wave optical source, but the present invention is not limited thereto. For example, a solid oscillator, such as an impact-ionization avalanche transit time (IMPATT) diode or a resonant tunneling diode; a backward wave oscillator (BWO); a molecular gas laser of a CO₂ laser excitation; a quantum cascade laser (QCL); or the like may be used.

Each of the above embodiments and modifications thereof have been descried while exemplifying the cases where a ZnTe crystal is used as an electro-optic crystal, but not limited thereto. Alternatively, for example, any of other crystals, such as ZnS, ZnSe, CdS, CdSe, CdTe, CdZnTe, GaAs, GaP, InP, and DAST, may be used. In this case, the plane direction of the crystal, the wavelength of the probe beam, or the like may be suitably determined.

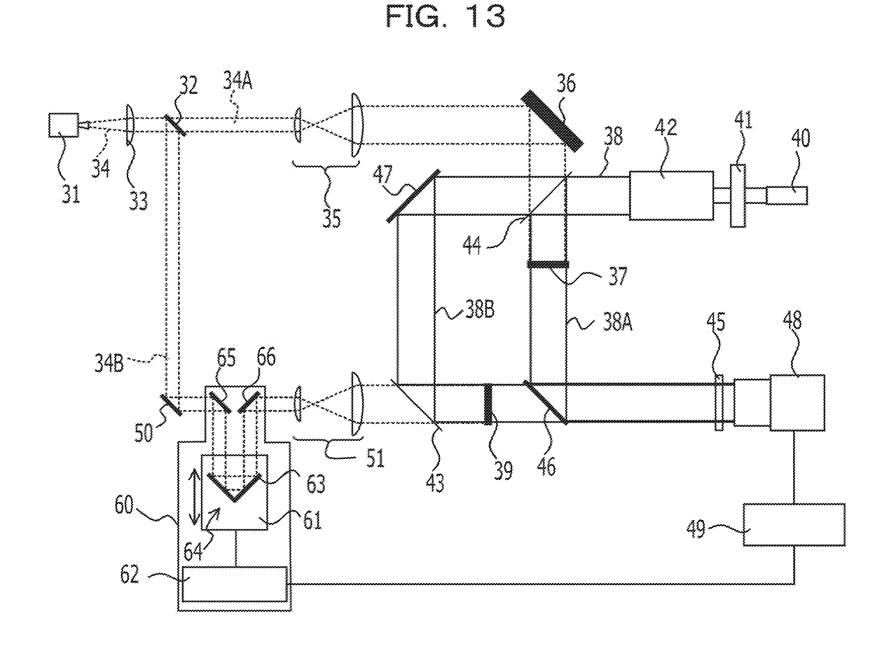

Furthermore, each of the above embodiments and modifications thereof have been described while exemplifying a transmission-type object imaging apparatus using a terahertz wave (electromagnetic wave) passing through an object, but not limited thereto. As illustrated in FIG. 13, for example, it may be a reflection-type object imaging apparatus using a terahertz wave (electromagnetic wave) reflecting from an object 36. In FIG. 13, the same structural components as those of the specific configuration example in the aforementioned second embodiment (see FIG. 6) are designated by the same reference numerals. Furthermore, FIG. 13 illustrates a modified example of the aforementioned second embodiment, but not limited thereto. Alternatively, it may be configured as a modified example of the configuration of each of the aforementioned embodiments and modifications thereof thereof.

Furthermore, the object imaging apparatus of each of the aforementioned embodiments and modifications thereof is applicable in the field of security, such as dangerous goods inspection in airports or the like; field of medicine, such as pathological diagnosis for cancer cells; field of drug manufacture and drug discovery; field of delivery inspection for farm products, foods, or the like; field of property distribution test for semiconductors or the like; field of nondestructive inspection for art objects; and so on.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An imaging apparatus, comprising:
an electromagnetic wave optical source configured to emit an electromagnetic wave in a continuous wave form;
an electromagnetic wave dividing unit configured to divide the electromagnetic wave from the electromagnetic wave optical source into a first electromagnetic wave beam and a second magnetic wave beam;
a probe optical source configured to emit a probe beam in a continuous wave form;
a probe-beam dividing unit configured to divide the probe beam into a first probe beam and a second probe beam;
a first electro-optic crystal on which the first electro-optic crystal is irradiated through an object and the first probe beam is incident;
a second electro-optic crystal on which the second electro-optic crystal is irradiated through an object and the second probe beam is incident;
an interference unit configured to allow the first probe beam from the first electro-optic crystal to interfere with the second probe beam from the second electro-optic crystal; and
an image pickup device configured to capture an interference figure between the first probe beam and the second probe beam from the interference unit.

2. The imaging apparatus according to claim 1, further comprising:
a time delay unit configured to produce a time delay of one of the first electromagnetic wave beam and the second electromagnetic wave beam or one of the first probe beam and the second probe beam; and
a control/arithmetic processing unit configured to acquire a phase image from a plurality of interference figures captured by the image pickup device by changing an amount of time delay by the time delay unit.

3. The imaging apparatus according to claim 2, wherein
the control/arithmetic processing unit controls the amount of time delay by the time delay unit so that the phase difference between the first probe beam and the second probe beam will be set to 0, π/2, π, or 3π/2.

4. The imaging apparatus according to claim 1, wherein
the probe optical source is a wavelength-variable probe optical source.

5. The imaging apparatus according to claim 4, further comprising:
a control/arithmetic processing unit configured to acquire one phase image from a plurality of phase images acquired from a plurality of interference figures captured by the image pickup device by changing the wavelength of the probe beam from the wavelength-variable probe optical source.

6. The imaging apparatus according to claim 1, further comprising:
an optical path length adjusting unit configured to adjust an optical path length between the first electro-optic crystal and the image pickup device or an optical path length between the second electro-optic crystal and the image pickup device.
